(19) United States
(12) Patent Application Publication
(10) Pub. No.: US 2014/0214671 A1
(43) Pub. Date: Jul. 31, 2014

(54) SERVER SIDE MOBILE PAYMENT PROCESSING AND AUTHENTICATION

(71) Applicants: Mahi DESILVA, San Mateo, CA (US); Sameer MERCHANT, San Mateo, CA (US)

(72) Inventors: Mahi DESILVA, San Mateo, CA (US); Sameer MERCHANT, San Mateo, CA (US)

(21) Appl. No.: 13/755,744

(22) Filed: Jan. 31, 2013

(51) Int. Cl. G06Q 20/38

(52) U.S. Cl. CPC G06Q 20/383
USPC 705/44

(57) ABSTRACT

A web browser inserts a user-neutral identifier into its webpage requests. A proxy server creates records of the webpage requests, and further processes these records to create and update profiles for the corresponding user-neutral identifiers. Upon receiving a webpage request including payment transaction information, which is redirected from a payment provider, the proxy server determines whether payment should be processed by analyzing one or more data elements in the request in view of the corresponding profile. Upon determining that the payment should be processed, the proxy server forwards the payment transaction information to a payment provider. By indexing the profiles according to user-neutral identifiers, rather than specific user information, user privacy can be maintained while still being able to authenticate whether a payment transaction is legitimate.

### FIELD OF THE INVENTION

The invention relates to collecting information from a mobile browser, and securing and transferring that information to a payment provider when desired by the end user of the device.

### BACKGROUND OF THE INVENTION

Computer users typically use user agent applications such as web browsers to purchase content and services over a computer network (e.g., Internet). In existing systems, individual websites which act as a retailer (e.g., by selling content and services) can connect users to a payment provider. Most simply, the retail website places an icon with associated script on the sales or checkout page, which directs the user to the payment provider when the “Checkout” icon is clicked. Information about the session, the user's purchased items, and other applicable information (e.g., account preferences) is passed to the payment provider via HTTP (hypertext transfer protocol) headers. The payment provider then processes this information in order to provide authentication, authorization, and financial audit information back to the retail website to complete the receipt. With this information, the website sends the requested item(s) for purchase to the user. Payment is collected by the payment provider, and passed to the publisher via monetary transfer thereby completing the transaction.

Existing systems of providing payment processing on the Internet is adequate for simple purchase transactions when the user (purchaser) and the seller have full direct internet access, and a relationship of trust has been established. However, there are several shortcomings to existing approaches to payments, especially in a mobile environment in which the purchaser is using, e.g., a smartphone or a tablet device.

In a mobile environment, for example, Internet access typically passes through multiple gateways and networks which, for the sake of efficiency or by way of trust or privacy policy, can modify the information being passed to Internet sites. Normally, the purpose of such modification is to reduce or eliminate HTTP header information, which is not viewed as being critical to connecting the user agent or browser to the website. In some cases, when the destination site is engaged in mobile commerce, mobile service providers block the transmission of certain HTTP header information unless the destination can be confirmed as being “trusted.”

Further, some mobile Internet services are provided via the client/server model. In this model, the user's mobile device hosts an application (typically a user agent like a web browser) that sends requests and receives web pages via a “proxy server.” The proxy server communicates with both the mobile device and the website to perform the following operations: retrieve the requested webpage, reformat the webpage for the mobile device and application, and then send the reformatted webpage to the mobile device. When this model is utilized, however, HTTP header information, which is critical to the payments provider, may be dropped from the communication path by either the device application (e.g., browser) or the proxy server. When this occurs, payments cannot be processed properly.

Moreover, it is becoming more and more commonplace for a single user to access websites utilizing multiple devices, including home and work computers, laptops, web-enabled phones, tablets, and televisions (TV's). As such, the same user may utilize multiple web browsers thus causing a proliferation in the number of “cookies” tracking the user's browsing habits, affinities, and behaviors. An individual user utilizing multiple devices may have to sign into a retail website more frequently from the different devices (and multiple locations), thereby creating a higher risk of intrusion to the user's account information and well as other private information.

Risk of exposure of private information is a concern of many consumers. The use of multiple devices increases this risk not only because the user has to sign in more frequently with the same retailer website, but also because many retailer websites force the user to create multiple accounts for the respective devices.

### SUMMARY OF THE INVENTION

The present invention is directed toward a method and system for tracking the Internet traffic of a web browser (particularly, a mobile browser), including requests and responses, and using such information to determine whether payment transaction requests should be allowed to be processed by a payment provider.

According to an exemplary embodiment, a proxy server receives URL requests (or webpage requests) from a web browser, as well as the responses thereto, and creates a record of the requests and responses. At least some of these webpage requests may be related to online purchases, and contain payment transaction information that the browser needs to send to a payment provider to process a payment transaction. This payment transaction information may contain, e.g., a merchant category code (MCC), session information, identification of purchased items, account preferences. Further, the browser may be programmed to include a user-neutral identifier within each request (e.g., in the header), in addition to the requested URL and payment processing information. This user-neutral identifier is not tied to user-specific information or user activity, thus maintaining the anonymity of the user(s) who issued the requests. However, the user-neutral identifier may be generated in such manner as to uniquely identify the web browser that issued the corresponding requests.

According to a further exemplary embodiment, the browser may be programmed to include additional information in each webpage request characterizing the device and/or service provider. Such additional information may identify the specific device or device type, network operator or service provider, current location of the device, etc. For instance, if the browser is programmed to provide information identifying a service provider, such information may be provided in the form of a mobile network code (MNC). As another example, if the browser is programmed to include information identifying the specific device, such information may be provided in the form of an IMSI (“International Mobile Subscriber Identity”) assigned to the subscriber identity module (SIM) of the mobile device. However, a MSISDN (“Mobile Subscriber Integrated Services Digital Network Number”) may also be included as a means of identifying the specific device, although the MSISDN technically identifies the subscription in the mobile network, and thus may change in time (e.g., due to number portability) for a particular mobile device.

According to a further exemplary embodiment, the records of the browser requests and corresponding responses may be processed by the proxy server to create and update a profile for the corresponding user-neutral identifier. This profile may contain information that can be used, when subsequent payment transaction requests are issued by the same browser, to perform a historical analysis to confirm the user is who she says she is.

For instance, the profile may contain information identifying which payment transaction device type, service provider, and/or location is normally associated with the user-neutral identifier based on the corresponding webpage requests. When a payment transaction request is received from a browser, the proxy server can use the profile to confirm whether the request came from the same device or device type, across the same service provider's network, and from the same general location as previous webpage requests attributed to that browser. This can help assure the payment provider that the payment transaction request is likely authentic. Conversely, if the profile indicates that the payment transaction request was transmitted using a different device (or device type), location, or service provider's network than expected, this can alert the proxy server (and subsequently the payment provider) of a higher risk of fraud associated with the transaction.

Furthermore, since this profile is maintained at a server-side facility instead of the user's device, the integrity of the profile information can be protected.

According to a further exemplary embodiment, the proxy server can enhance user security by analyzing the payment transaction requests from the browser in order to determine whether they should be permitted to pass to the payment provider(s). For example, the proxy server may look at the user-neutral identifier of the request, along with other data inserted into the request by the browser (e.g., device type, location, or even the requested URL), to determine whether or not the payment transaction data should be passed on to the payment provider. The corresponding profile may contain “rules,” implemented at the user's discretion, defining what type(s) of payment transaction requests are suitable to be passed on to the payment provider. As such, the proxy server can enforce a “rule” whereby payment transaction requests from the browser are passed on to a payment provider only if such requests are transmitted by a preapproved device (or device type), from a preapproved location, and/or using a preapproved service provider.

Furthermore, the proxy server may implement other types of rules defining whether or not payment transaction requests are allowed to pass to corresponding payment providers. For instance, the proxy server may allow for a particular service provider to specify a list of Internet sites which are approved for (or prohibited from) receiving payment transaction data from customers of the provider. Accordingly, when the proxy server receives a payment transaction request identifying the particular service provider (or, alternatively, if the proxy server is integrated as part of the service provider's network), the proxy server may compare the requested URL with a list of approved (or prohibited) URL's to determine whether or not the request should be permitted to pass to the payment provider. This would allow the service provider to block disreputable Internet retailers and content providers from interacting with the service provider's users.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein

FIG. 1 illustrates the basic architecture of a computing device that can operate as either a client device, a proxy server, or other server-side device according to exemplary embodiments of the present invention;

FIG. 2 illustrates the basic architecture of a web browser implemented on a client device according to an exemplary embodiment of the present invention;

FIG. 3 illustrates a system for implementing principles of the present invention according to an exemplary embodiment;

FIG. 4 illustrates software modules of a proxy server according to an exemplary embodiment of the present invention;

FIG. 5 is a flow chart illustrating a process performed by a proxy server according to an exemplary embodiment utilizing a profile that is updated according to browsing activity;

FIG. 6 is a flow chart illustrating a process performed by a proxy server according to an exemplary embodiment utilizing a profile that contains user-designated settings;

FIG. 7 is a flow chart illustrating a process performed by a proxy server according to an exemplary embodiment utilizing a “whitelisting” feature; and

FIG. 8 is a data flow diagram illustrating interactions between a client device, a server-side facility, and a web server according to an exemplary embodiment of the present invention.

The drawings will be described in detail in the course of the detailed description of the invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

The present invention seeks to improve the process of conducting payment transactions over the Internet. The present invention may be used to gather information regarding users' Internet browsing activity, in a manner that limits the intrusion on the users' privacy, and glean profile information that can be used for authenticating payment requests. The present invention may also be used to provide a common infrastructure for interacting with payment providers regardless of the type of device used, the locations of such devices, and the website visited.

The principles of the present invention may be implemented in a mobile environment in which users are able to browse the Internet using their mobile devices (phone, tablet computer, etc.), e.g., via a 3G or 4G-compliant network. However, the present invention is not limited to a mobile implementation, and the principles described herein may also be applied to a desktop browsing environment.

According to an exemplary embodiment, a proxy server can generate records of webpage requests (e.g., URL requests) issued by a particular browser, and then utilize these records to generate and update a profile. To facilitate this, the client browser may generate a unique identifier that is “user-neutral” in the sense that it is not comprised of any information that is specifically associated with a particular user. A web browser is not required to access a webpage to receive the user-neutral identifier, unlike cookies. For instance, this user-neutral identifier may be programmed into the browser before the browser is installed on a user device. It is also possible for the user-neutral identifier to be generated by the browser (or a remote location) after installation of the browser, e.g., when the browser is initiated or used for the first time. At any rate, the user-neutral identifier is embedded as an attribute of the browser, rather than the user, and works across all domains/traffic that might be generated by the user.

Further, the browser may incorporate the user-neutral identifier into its webpage requests prior to transmission, so that the server-side facility can use data from these requests to generate and/or update a profile that corresponds to the user-neutral identifier. This profile can thus provide information regarding a particular user's device (or type of device), general location, and service provider, while still maintaining the user's anonymity. Such information can help assure a payment provider, through the use of second and third order authentication routines, that the user is who she claims to be. As an example of such second and third order authentication routines, when a request is received, the corresponding profile may be looked up (using the user-neutral identifier) for purposes of determining whether the current request matches previous requests in regard to one or more of: the originating device, the location of the user, shopping history (in case such information is collected in the profile), etc. Any mismatches could alert the payment provider to a higher risk of fraud.

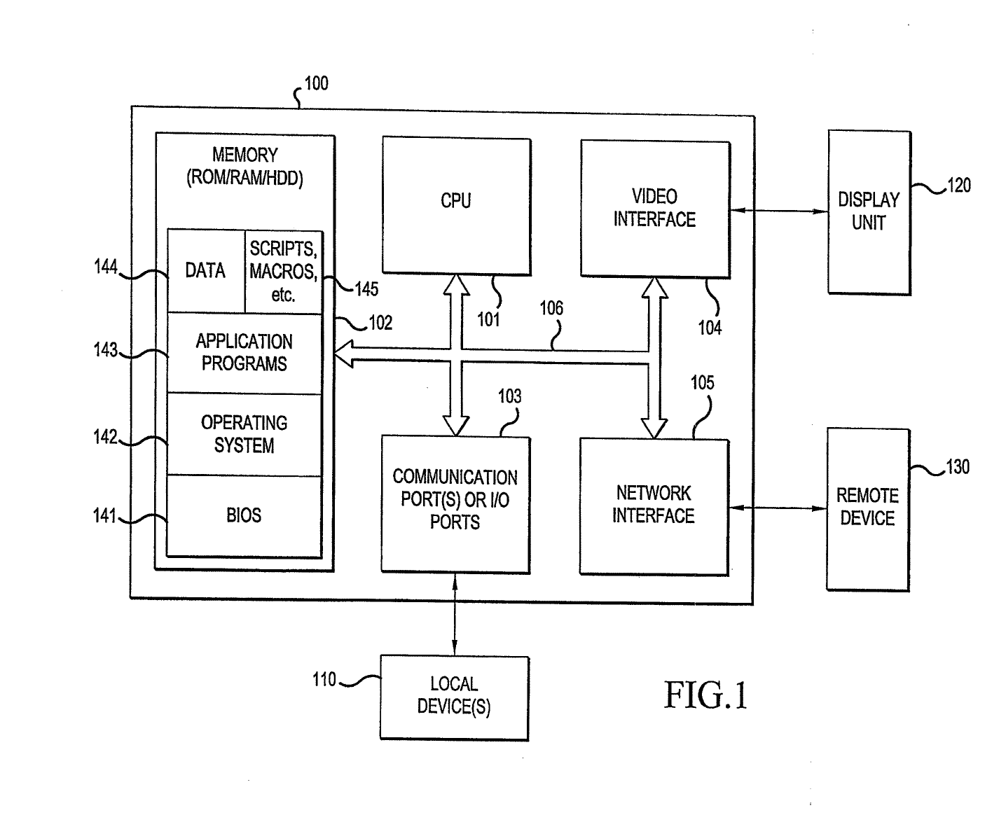

FIG. 1 illustrates a generalized computing device 100 that can be used as an environment for implementing various aspects of the present invention. For instance, the computing device 100 may be implemented as a client device, i.e., a user's computing device on which a web browser is installed to request webpages or resources from the server. Examples of such client devices include a mobile device (e.g., a cellphone, a smartphone, a tablet computer, etc.) or a general purpose desktop computer such as a PC. However, the computing device 100 of FIG. 1 may also be implemented as a server-side device, e.g., as a web server, a proxy server, or another specialized computing device as will be describe in more detail below.

In FIG. 1, a computing device 100 has various functional components including a central processor unit (CPU) 101, memory 102, communication port(s) 103, a video interface 104, and a network interface 105. These components may be in communication with each other by way of a system bus 106.

In FIG. 1, a computing device 100 has various functional components including a central processor unit (CPU) 101, memory 102, communication port(s) 103, a video interface 104, and a network interface 105. These components may be in communication with each other by way of a system bus 106.

The memory 102, which may include ROM, RAM, flash memory, hard drives, or any other combination of fixed and removable memories, stores the various software components of the system. The software components in the memory 102 may include a basic input/output system (BIOS) 141, an operating system 142, various computer programs 143 including applications and device drivers, various types of data 144, and other executable files or instructions such as macros and scripts 145. For instance, the computer programs 143 stored within the memory 102 may include any number of applications, including a web browser and other web applications that may be executed in accordance with principles of the present invention.

In FIG. 1, the communication ports 103 may be connected to one or more local devices 110 such as user input devices, a printer, a media player, external memory devices, and special purpose devices such as, e.g., a global positioning system receiver (GPS). Communication ports 103, which may also be referred to as input/output ports (I/O), may be any combination of such ports as USB, PS/2, RS-232, infra red (IR), Bluetooth, printer ports, or any other standardized or dedicated communication interface for local devices 110.

The video interface device 104 is connected to a display unit 120 which may be an external monitor or an integrated display such as an LCD display. The display unit 120 may have a touch sensitive screen and in that case the display unit 120 doubles as a user input device. The user input device aspects of the display unit 120 may be considered as one of the local devices 110 communicating over a communication port 103.

The network interface device 105 provides the device 100 with the ability to connect to a network in order to communicate with a remote device 130. Such network, which in FIG. 1 is only illustrated as the line connecting the network interface 105 with the remote device 130, may be, e.g., a local area network or the Internet. The remote device 130 may in principle be any computing device (e.g., client or server) with similar communications capabilities as the device 100.

It will be understood that the device 100 illustrated in FIG. 1 is not limited to any particular configuration or embodiment regarding its size, resources, or physical implementation of components. For example, more than one of the functional components illustrated in FIG. 1 may be combined into a single integrated unit of the device 100. Also, a single functional component of FIG. 1 may be distributed over several physical units. Other units or capabilities may of course also be present.

In an exemplary embodiment, various aspects of the present invention may be incorporated into, or used in connection with, the components and/or functionality making up a web browser installed as an application on a device 100. While the terms “web browser” and “browser” are used throughout this specification, it should be understood that such terms are not intended to limit the present application only to traditional web browser programs, but instead cover any type of user agent or web application that is capable of sending URL requests for data resources (including, but not limited to, webpages) over the World Wide Web consistent with the principles of the present invention.

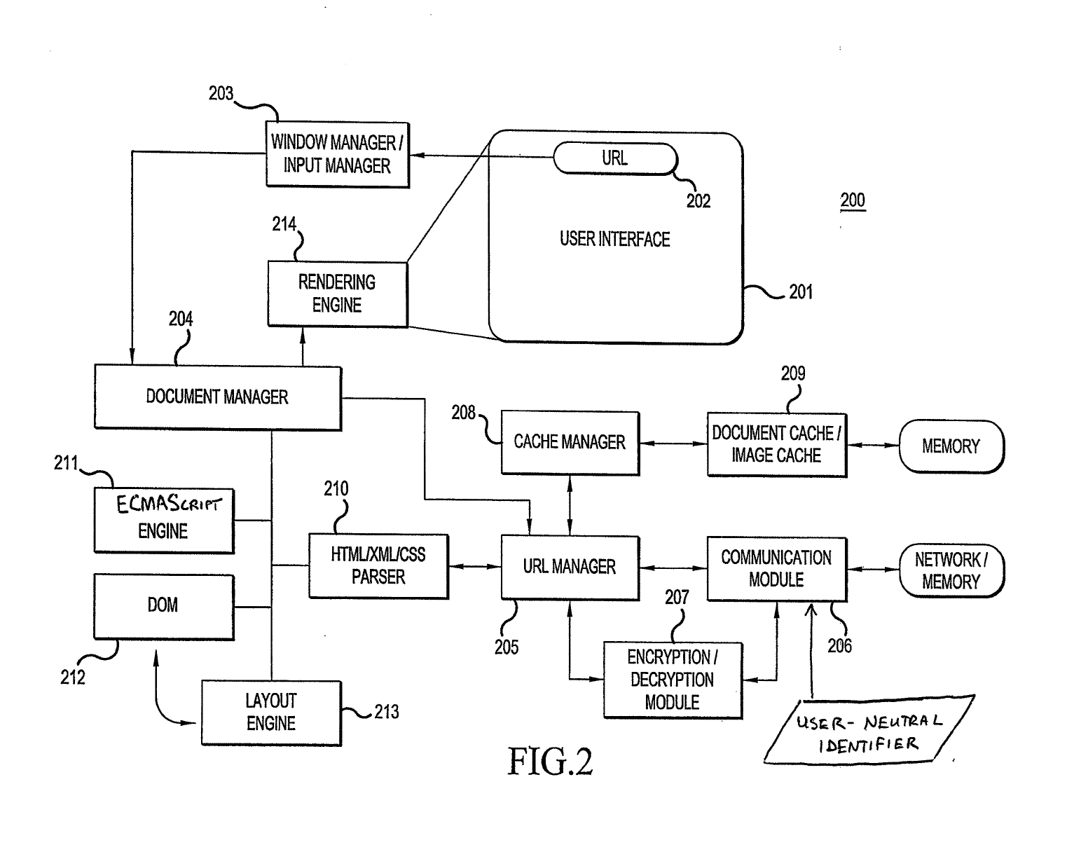

FIG. 2 illustrates the basic architecture of a web browser 200 that can be used in connection with the present invention. Particularly, FIG. 2 shows an example of various modules that may be present in such a web browser 200. The modules will typically be software modules, or otherwise implemented by a programmer in software, and may be executed by the CPU 101. However, it is also possible for any of the modules of FIG. 2 to be implemented as hardware, a combination of hardware and software, or “firmware,” as will be contemplated by those skilled in the art.

The web browser 200 presents the user with a user interface 201 that may be displayed on the display unit 120 shown in FIG. 1. The user interface 201 may include an address field 202 in which the user may input or select the URL of a document or a service he or she wants the browser 200 to retrieve. For example, the user may use an input device (e.g., keyboard) to type in the URL in the address field 202. The address field 202 may also be a link that is displayed and may be activated by the user using a pointing device such as a mouse. Alternatively the URL may be specified in the code of a document or script already loaded by the web browser 200.

In any case, the URL may be received by a window and input manager 203 that represents the input part of the user interface 201 associated with, or part of, the browser 200. The URL may then be forwarded to a document manager 204, which manages the data received as part of the document identified by the URL.

The document manager 204 forwards the URL to a URL manager 205, which instructs a communication module 206 to generate a webpage request, i.e., a request for access to the identified resource. The communication module 206 may be capable of accessing and retrieving data from a remote device 130 such as a server over a network using the hypertext transfer protocol (HTTP), other protocols such as HTTP Secure (HTTPS) or file transfer protocol (FTP), or any proprietary communication protocol delivered over the Transmission Control Protocol/Internet Protocol (TCP/IP) lower-level protocol. The communication module 206 may also be capable of accessing data that is stored in the local memory 102 of the computing device 100.

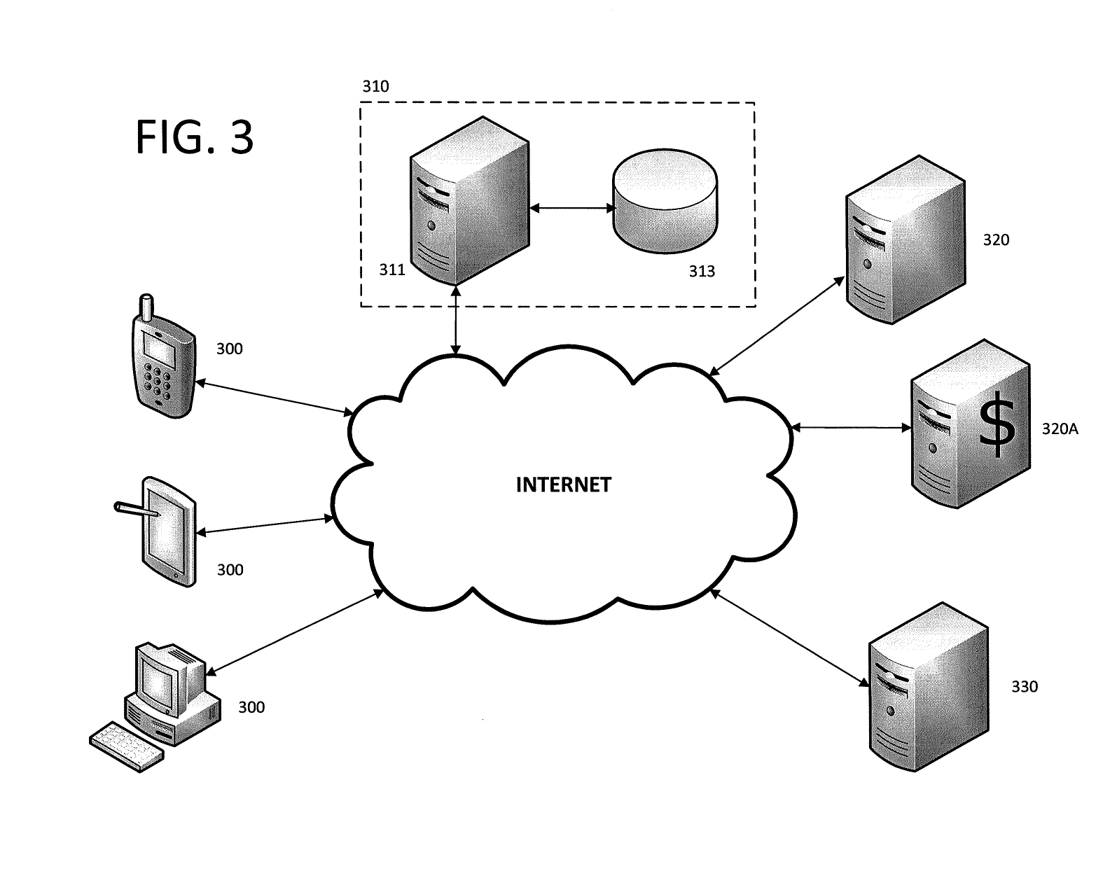

According to an exemplary embodiment of the present invention, the communication module 206 is programmed to include within each webpage request other types of information in addition to the requested URL. As shown in FIG. 2, for instance, a user-neutral identifier is provided to the communication module 206 to be inserted into the webpage requests. Preferably, each webpage request that is generated by communication module 206 includes the same user-neutral identifier, which is designed to uniquely identify the web browser 200 from other browsers 200 installed on other devices 100. As mentioned earlier, this user-neutral identifier may be programmed somewhere within the web browser 200 before such browser 200 is installed on the computing device 100. Alternatively, the browser 200 may be programmed to generate the user-neutral identifier upon installation, and register it with a proxy server (which will be described in more detail below in reference to FIG. 3) or another central location to ensure its uniqueness with regard to the registered user-neutral identifiers corresponding to other browsers 200. It is also possible to have a server-side facility (or other remote location) generate the user-neutral identifier and transmit it to the browser 200 when an initiation process is performed or when the browser 200 is first used. Furthermore, it is possible for a user-neutral identifier to be regenerated for replacing the previous one in the browser 200; this could occur periodically or when the browser 200 is updated to a new version.

Further, communication module 206 may also insert other data elements into each webpage request, in addition to the requested URL and user-neutral identifier. These additional data elements may include one or more of the following: type of computing device 100 (e.g., make and model number, or more generic description); unique identifier of the computing device 100 (e.g., serial number, or other indicia whose function is to identify the physical device 100 itself and not just distinguish it from makes and models); identity of a network service provider that services the computing device 100; and geographical location or region of the computing device 100 when transmitting the webpage request (e.g., obtained using GPS (global positioning system) functionality of the device 100). The insertion of such additional data elements can increase the amount of data that can be collected by the proxy server without requiring such server to intrude or impact the performance of the browser 200 and corresponding device 100.

Referring again to FIG. 2, the web browser 200 may include an encryption/decryption module 207 to handle communication between the URL manager 205 and the communication module 206, if communication outside the computing device 100 is required to be encrypted (e.g., as specified by the protocol used for accessing the URL).

The data received by the communication unit 206 in response to a webpage request is forwarded to the URL manager 205. The URL manager 205 may then store a copy of the received content in local memory 102 using a cache manager 208 which administers a document and image cache 209. If the same URL is requested at a later time, the URL manager 205 may request it from the cache manager 208, which will retrieve the cached copy from the cache 209 (unless the cached copy has been deleted) and forward the cached copy to the URL manager 205. Accordingly, it may not be necessary to retrieve the same data again from a remote device 130 when the same URL is requested a second time.

The URL manager 205 forwards the data received from the communication port 206 or cache 209 to a parser 210 capable of parsing content such as HTML, XML and CSS (the parser 210 may also be capable of parsing a proprietary markup language or an optimized representation of a markup language as well). The parsed content may then, depending on the type and nature of the content, be processed further by an ECMAScript engine 211, a module for handling a document object model (DOM) structure 212, and/or a layout engine 213.

This processing of the retrieved content is administered by the document manager 204, which may also forward additional URL requests to the URL manager 205 as a result of the processing of the received content. These additional URL's may, e.g., specify images or other additional files that should be embedded in the document specified by the original URL.

When the data representing the content of the specified document has been processed it is forwarded from the document manager 204 in order to be rendered by a rendering engine 214 and displayed on the user interface 201.

The various modules thus described are executed by the CPU 101 of computing device 100 as the CPU 101 receives instructions and data over the system bus(es) 106. The communications module 206 communicates with the remote device 130 using the network interface 105. The functionality of various modules in FIG. 2 may of course be integrated into fewer larger modules. Also, the functionality of a single module in FIG. 2 may be distributed or replicated over several modules.

It will further be understood that, while the web browser 200 described above may be implemented as an application program 143 of the computing device 100, some of the browser's 200 functionality may also be implemented as part of the operating system 142 or even the BIOS 141 of the device 100. Further, the content received in response to a webpage request may include data 144, script 145, or a combination thereof.

Reference is now made to FIG. 3, which shows a system in which principles of the present invention may be implemented, according to exemplary embodiments. As shown in FIG. 3, a number of client devices 300 are connected to the Internet. As shown in the figure, such client devices 300 may include mobile devices, such as a phone or tablet computer or a general purpose desktop computer (e.g., PC). Each client device 300 has a web browser 200 installed therein for requesting and retrieving webpages and other resources over the World Wide Web. Also, in FIG. 3, reference numeral 320 indicates a web server which host websites from which webpages and other resources may be requested and retrieved via the Internet. Further, reference numeral 320A indicates a particular type of web server which hosts a website that serves as a retailer, e.g., by selling content and/or services online. Such web servers 320A permit the user of a client device 300 to initiate a payment transaction according to principles delineated below. For purposes of simplicity, only two web servers 320, 320A are shown. However, it will be readily understood that there is no limitation as to the number or types of web servers 320, 320A that can be visited and recorded in accordance with the principles of the present invention. Furthermore, in FIG. 3, reference numeral 330 refers to a payment provider. This payment provider 330 may be a facility or service provider that offers merchants online services for accepting electronic payments in one or more method. For example, the payment provider 330 may provide online services for accepting payments via credit card, real-time bank transfer, or other bank-based payment (e.g., debit card).

In addition, FIG. 3 illustrates a server-side facility 310 which includes a proxy server 311 and a database 313. The proxy server 311 may generally correspond to the basic architecture of a computing device 100 described above in connection with FIG. 1. Further, although the proxy server 311 and database 313 are illustrated as separate elements, their functionality as described hereinbelow may be combined into a single computing device 100. Alternatively, the database 313 could be implemented in a separate device 100 than the proxy server 311. Further, it is also possible that the various functionalities/modules of the proxy server 311, as will be described hereinbelow, may be distributed across multiple computing devices 100. For purposes of this specification, the term “proxy server 311” will be used to refer to a single computing device 100 or a collection of devices 100 that perform the corresponding functionalities as described herein. Furthermore, while the proxy server 311 and database 313 are described and illustrated as being implemented in a server-side facility 310, this is not intended to impart any requirement as to physical proximity between such elements. For instance, it is possible for the proxy server 311 and database 313 to be maintained in different locations and communicatively connected, e.g., via wide area network (WAN) or even the Internet.

One of the functions of the proxy server 311 may be to register user-neutral identifiers that are embedded in the web browsers 200 installed on the respective client devices 300. For instance, the user-neutral identifiers may be programmed in the browsers 200 and transmitted to the proxy server 311 as part of a registering process that occurs, e.g., upon first use of each browser 200. Alternatively, it is possible for the proxy server 311 (or another computing device at the server-side facility 310) to generate the user-neutral identifiers and transmit them to the respective browsers 200 after they are registered. For instance, the user-neutral identifier may be transmitted to a browser 200 during an initiation or updating of the browser 200. One of the purposes of the proxy server 311 (or other device 100) to register the user-neutral identifier is to ensure its uniqueness with regard to the other registered user-neutral identifiers. Other purposes may be served as well by the registration process, e.g., to ensure that each user-neutral identifier conforms to a certain format (e.g., numerical or alpha-numerical string of a certain length) and/or to confirm that the user-neutral identifier does not provide any user-specific information that could hinder user anonymity.

Other possible functions of the server-side facility 310, and particularly those of the proxy server 311, will now be discussed. According to an exemplary embodiment, the proxy server 311 may receive and process web browsing requests from a client device 300, as well as facilitate webpage delivery from the corresponding web server 320. It is also possible for such proxy server 311 to operate as a transcoding server (or else operate in conjunction with a transcoding server) which modifies the code of the retrieved webpages to make them more suitable to the processing and/or display capabilities of the requesting client device 300. Such transcoding functionality may be especially useful for mobile client devices 300 which have small displays and limited processing capability. Furthermore, the proxy server 311 could be programmed to modify and/or filter the data of the retrieved webpages before it is forwarded to the client device 300, e.g., according to the user's preferences or browsing habits. This could be accomplished by, e.g., programming the proxy server 311 with explicit instructions or settings from a user or service provider. For example, a user could tell the proxy server 311 to filter out any cookies from the retrieved webpage. In this way, the proxy server 311 can provide an additional means by which a user can exert control over what data is received in the client device 300.

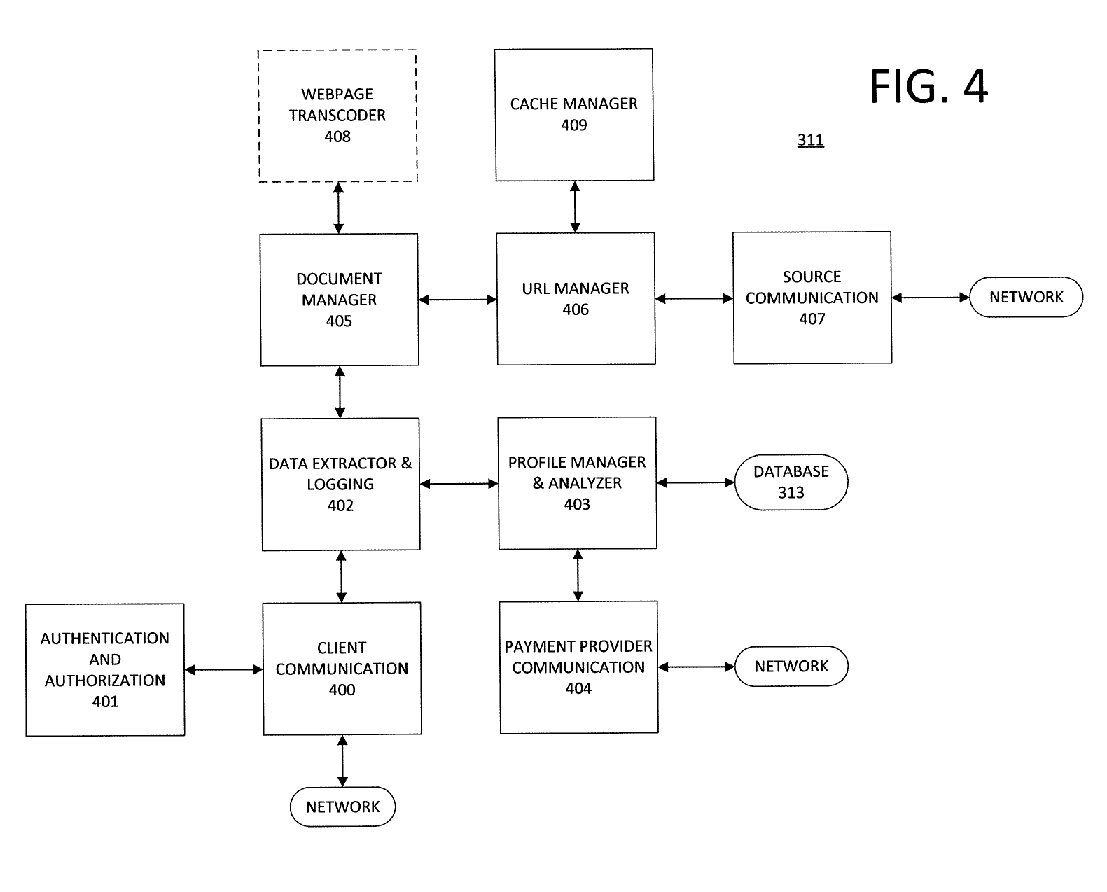

Reference is now made to FIG. 4, which illustrates how the proxy server 311 may be organized in terms of software modules installed on a computing device, according to an exemplary embodiment of the present invention. Among the modules of FIG. 4 is a client communication module 400 for receiving webpage requests (and other data) from client devices 300. The client communication module 400 may be configured to receive HTTP or HTTPS requests over TCP/IP, but consistent with the principles of the invention, the communication device 400 may also communicate using other standards or proprietary protocols and other types of networks than the Internet. By way of example, the client communication module 400 may be configured to communicate, directly or indirectly, over a mobile telephone network such as GSM, UMTS, CDMA or over wireless networks such as Wi-Fi Wireless LAN (IEEE 802.11) or WiMAX (IEEE 802.16).

The client communication module 400 may be connected to an authentication and authorization module 401, which determines whether a requesting client device 300 needs to be authenticated (and performs such authentication if necessary) and/or whether the client device 300 is authorized to access requested webpages using the proxy server 312. Authentication and/or authorization can be handled by methods that are well known by those skilled in the art. One example of such methods is username/password combinations.

In FIG. 4, a data extractor and logging module 402 is provided for extracting data from and/or generating a record of each webpage request received from a client device 300. According to an exemplary embodiment, this data extractor and logging module 402 extracts the user-neutral identifier and the requested URL from the webpage request. In addition, the logging module 402 may (optionally) extract one or more other data elements which were inserted into the request by the corresponding web browser 200, examples of which include: type of client device 300 (e.g., make and model number), unique identifier of the client device 300 (e.g., an IMSI, serial number, or possibly MSISDN); identity of network service provider that services the client device 300 (e.g., in the form of an MNC); and geographic location or region of the client device 300 when the webpage request was transmitted.

The user-neutral identifier, URL, and any other extracted data elements may be recorded (e.g., in a log file) by the data extractor and logging module 402 thereby creating a record of the webpage request. Each record may be stored in local memory 102 (FIG. 1) of the proxy server 311 until such time that it will be used to create or update a profile for the corresponding user-neutral identifier. At such time, the records may be retrieved by the profile manager and analyzer module 403 for purposes of creating or updating a profile, which corresponds to the extracted user-neutral identifier and which is stored in database 313.

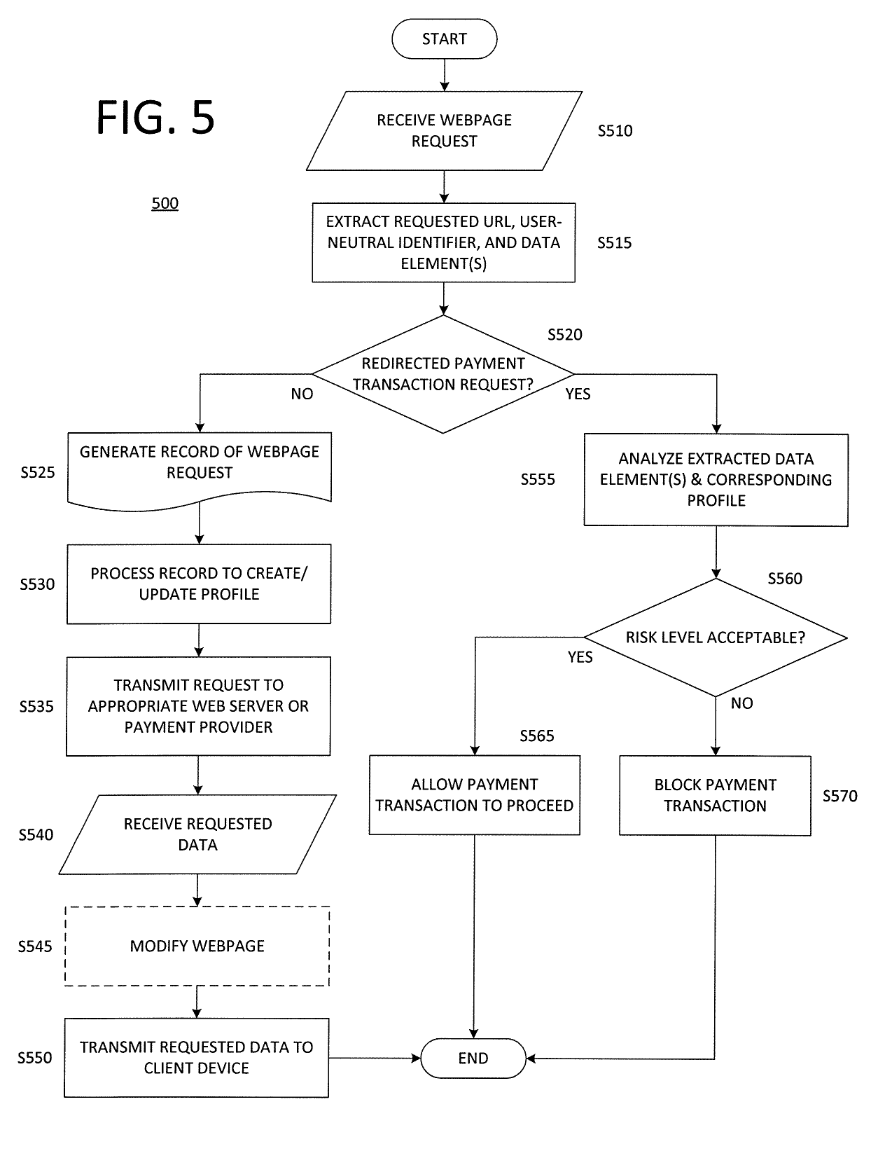

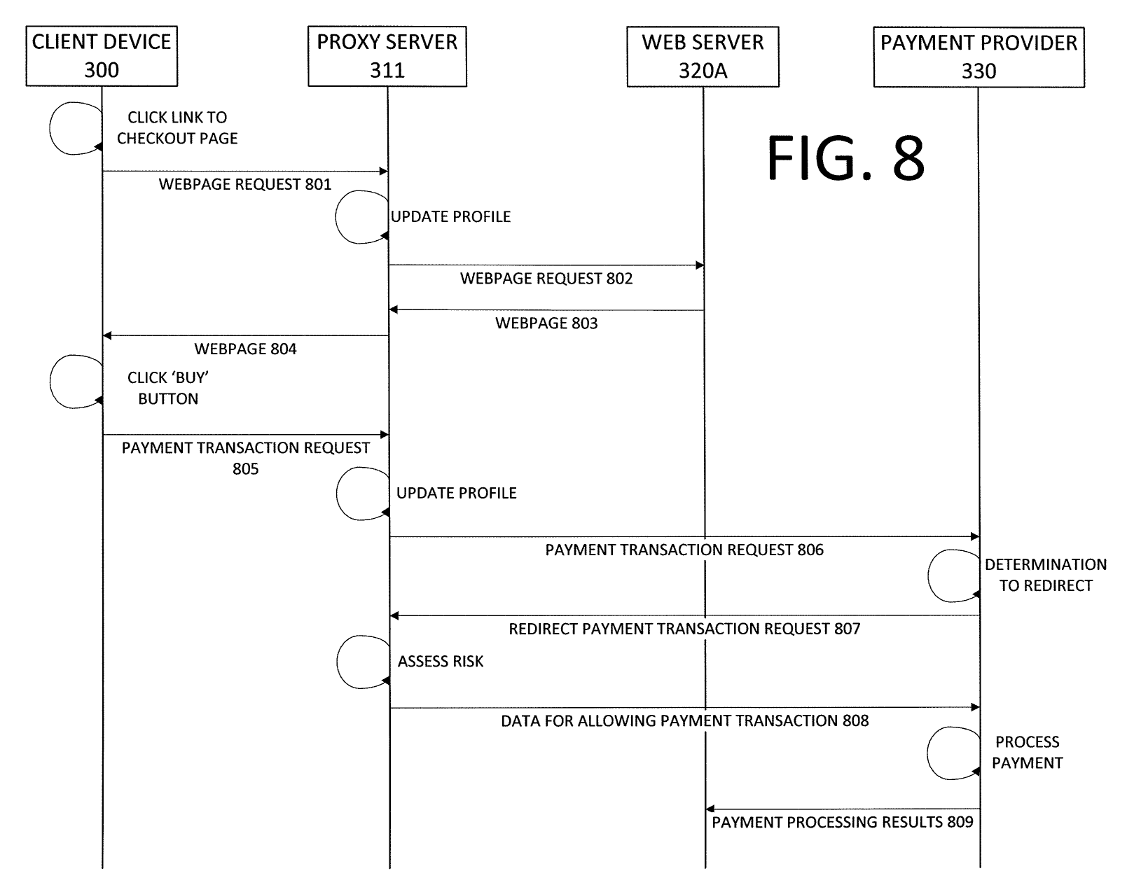

If a webpage request is conveying payment transaction information to a payment provider 330, however, the profile manager and analyzer module 403 may perform another function. Specifically, if a webpage request is received by the proxy server 311 as a result of a redirect from the payment provider 330, the profile manager and analyzer module 403 may identify the request as a payment transaction request that requires risk assessment. Such a redirect might occur when a mobile browser attempts to transmit the payment transaction request to the payment provider 330, but the payment provider 330 realizes that certain critical information was dropped, e.g., by the mobile browser itself, the mobile network, or perhaps even the proxy server 311. In response to determining that the request is a redirected payment transaction request, the profile manager and analyzer module 403 may proceed to examine the user-neutral identifier and data element(s) that were extracted from the request, retrieve the corresponding profile from the database 313, and analyze the data element(s) in view of the profile to analyze the risk involved with the underlying transaction. If this risk is acceptably low, the profile manager and analyzer module 403 may inform the payment provider communication module 404, which can then forward information, necessary for allowing the payment transaction to be processed, to an appropriate payment provider 330 via a network (e.g., Internet). These operations will be described in more detail below in connection with FIGS. 5 and 8.

Referring again to FIG. 4, the data extractor and logging module 402 may also forward the URL of each webpage request to the document manager 405, much in the same way that the window and input manager 203 of a web browser 200 forwards a URL to the document manager 204 (as discussed above with reference to FIG. 2). The document manager 405 of FIG. 4 may forward the URL to a URL manager 406, which then instructs a source communication module 407 to request access to the identified resource. The source communication module 407 may be capable of accessing and retrieving data from a web server 320 over the Internet using the hypertext transfer protocol (HTTP) or some other protocol such as HTTPS or FTP. The source communication module 407 may also be capable of accessing data that is stored in local memory 102. If the networks, communication standards, and protocols used by the client communication module 401 and the source communication module 407 are the same, these two modules may be implemented as a single communication module handling all communications to and from the proxy server 311.

In response to the request sent by the source communication module 407, webpage data may be received in the form of one or more files. The received data may then be forwarded to the URL manager 406.

In an exemplary embodiment, the URL manager 406 may then store a copy of the received webpage in local memory 102 using the cache manager 409. According to this embodiment, if the same URL is requested at a later time (even from a different client device 300), the URL manager 406 could request it from the cache manager 409. This corresponds to the caching performed by a local web browser installed on a client device 300, as described above with reference to FIG. 2, and also to methods performed by proxy servers, as will be readily apparent to those of ordinary skill in the art.

Referring again to FIG. 4, the URL manager 406 may forward the received webpage data to the document manager 405 for further processing. This may include, e.g., extracting any cookies from the webpage and automatically deleting them or possibly storing them in local memory 102 for future reference. Also, it is possible that the proxy server 311 could query parameters/settings associated with the client device 300 (e.g., based on the user-neutral identifier) and/or analyze extracted cookies for use in modifying the webpage based on the user's interests. For example, certain types of advertising could be injected into or deleted from the webpage before it is forwarded to the client device 300. Another option is to program the document manager 406 to filter or modify the webpage data according to parameters/settings included in the original webpage request. This would allow the user of the client device 300 to exert some control over what types of data is returned to the client device 300. The document manager may also be configured to filter content according to applicable law, manage 404 responses, etc.

According to a specific example, the document manager 405 may under certain circumstances send the received webpage data to a webpage transcoder 408. This webpage transcoder 408 is optionally included, as indicated by the dotted lines in FIG. 4, if the proxy server 311 is intended to function as a transcoding server as well. As such, the webpage transcoder 408 can be used to convert the content and/or format of the webpage in accordance with the processing and/or display capabilities of a particular type of client device 300. For instance, if the client device 300 is a mobile device, its display will typically be smaller and have a different aspect ratio than the desktop computers (e.g., PC's) for which most webpages are designed. Also, certain mobile devices (e.g., phones) may not include the full functionality of their desktop counterparts. As such, the webpage transcoder 407 may be programmed to re-encode the webpage to make it more suitable to the display and/or processing capabilities of a mobile client device 300 that requested the webpage.

Referring again to FIG. 4, after the retrieved webpage is processed (and possibly transcoded), it can be forwarded from the document manager 405 to the client communication module 401 for transmission to the particular client device 300 which requested it.

Reference will now be made to FIG. 5, which is a flow chart illustrating a process 500 that may be performed by the proxy server 311 according to an exemplary embodiment utilizing profiles that are created and updated according to a client device's 300 browsing activity. It should be noted that this figure is provided for purpose of example only, and is not to be construed as limiting the present invention. For example, the sequence of operations illustrated in FIG. 5 may be altered, and some of the illustrated operations may be omitted or performed by other devices.

As shown in FIG. 5, process 500 may be initiated when the proxy server 311 receives a webpage request, as shown in operation S510, which was either transmitted by a web browser 200 installed in a client device 300 or redirected from a payment provider 330. According to operation S515, the proxy server 311 (particularly, the data extractor and logging module 403) extracts from the webpage request the user-neutral identifier, the requested URL, and one or more other data elements which the originating browser 200 inserted into the request.

In addition to extracting data element(s) according to S515, the proxy server 311 might be able to gather its own information in regard to the webpage request. For instance, if the data element(s) inserted into the webpage request by the browser 200 does not include the location of the client device 300 at the time the request was transmitted, the proxy server 311 might still be able to obtain such information from the mobile service provider of the client device 300. This could be accomplished via an interface (not shown in figures) between the proxy server 311 and the service provider. It is also possible that the proxy server 311 could be able to obtain other types of information (e.g., device type or identity of service provider) from such an interface to the service provider, instead of extracting it directly from the webpage request. For purposes of convenience, in the description that follows, the term “extracted data element(s)” and the like will be considered to be inclusive of any such information that the proxy server 311 obtains from the service provider rather than direct extraction from the webpage request.

In operation S520, the proxy server 311 analyzes the webpage request to determine whether or not it is a payment transaction request, redirected from a payment provider 330, and upon which risk assessment should be performed in regard to the underlying transaction.

If it is decided in S520 that the website request is not a payment transaction request redirected from a payment provider 330, then processing proceeds to operation S525 (which will be described later). On the other hand, if the decision in S520 is that the request is a redirected payment transaction request, then processing proceeds to operation S555 in which the proxy server 311 (e.g., the profile manager and analyzer module 403) analyzes the extracted data element(s) to ascertain a risk level associated with the payment transaction.

For instance, the payment processing request may be redirected to the proxy server 311 as follows. The request may initially be transmitted by the web browser 200 to the payment provider 330, e.g., as a result of the user of the client device 300 clicking the “Buy” button on a retailer's website. Upon receiving the request from the client device 300, the payment provider 330 may determine that the request is missing required information, e.g., which was stripped from the HTTP header information by the browser 200 or a network entity, and thus redirected the request to the proxy server 311. In response to this determination, the payment provider 330 may be programmed to redirect the payment processing request to the proxy server 311, so that the missing information can be obtained from the proxy server 311 (assuming that the risk level is acceptable).

To perform the analysis of S555, the proxy server 311 may query the database 313 for a profile corresponding to the same user-neutral identifier as the webpage request. This profile contains information gleaned from records of previous webpage requests, as will be described in more detail below in connection with operations S520 and S530. For instance, this profile may contain information regarding the unique identifier of the client device 300, or the type of device 300 (e.g., make and model), that is associated with the extracted user-neutral identifier. The profile may also contain information (e.g., one or more MNC's) identifying the network service provider(s) which serviced the corresponding client device 300 when previous webpage requests were transmitted by that device 300. The profile may also contain information about specific or general geographic location(s) of the client device 300 when previous requests were transmitted therefrom.

According to one embodiment, each profile may comprise a collection of records of one or more webpage requests, corresponding to a particular user-neutral identifier, which were previously received by the proxy server 311. This would allow for an analysis to be performed in operation S555 to determine, based on past history, whether the information in the extracted data element(s) (e.g., unique device identifier, device type, device location, and/or service provider) is consistent with what would be expected.

For instance, if the current payment transaction request indicates that it is being transmitted by the same device or type of device, from the same general location, and across the same service provider's network as the previous webpage requests (as indicated by the profile), the current payment transaction request is more likely to be authentic. On the other hand, if the current request indicates that it was transmitted by a different device 300 or type of device 300, or across a different service provider's network than previous webpage requests, this could alert the proxy server 311 of a high risk of fraud associated with the request. Similarly, if the current payment transaction request indicates that it was sent from a different country (or otherwise far away from the location normally associated with the user-neutral identifier), this could indicate a high risk of fraud or possible theft of the device 300. This analysis could comprise simple comparisons between data elements in the current payment transaction request and previous webpage requests, or include further statistical processing.

The profile need not be embodied simply as a collection of records of previous webpage requests corresponding to the same user-neutral identifier. According to other embodiments, the profile may reflect the results of different statistical processes performed on the records in order to determine what information should be expected within the data element(s) of a valid payment transaction request. As such, operation S555 may be used to compare the data element(s) of a current payment transaction request to “expected” value(s) as set forth in the profile.

It is also possible for the profile to contain other types of information for use in the analysis of S555, in addition or alternative to information obtained from the records of previous webpage requests. According to an exemplary embodiment, for instance, a user may be allowed to designate rules for blocking the payment transaction request or permitting it to pass to the payment provider, on the basis of the extracted data element(s). The user can use the browser 200 to input these rules, and the rules can be transmitted by the browser 200 to the proxy server 311 as requests. The browser 200 can also insert the user-neutral identifier in such requests, thereby allowing the proxy server 311 to set these rules in the corresponding profile of the database 313. For example, the user can specify that a payment transaction request should only be permitted to pass to the payment provider if the request contains the value “HTC Incredible” as the data element for device type and/or the value “Vodafone” as the data element identifying the service provider.

According to another exemplary embodiment, it is also possible for different network service providers to designate to the proxy server 311 lists of websites (e.g., identified by URL's) or retailers (e.g., identified by MCC's) which its customers are permitted to, or prohibited from, conduct payment transactions with. In this embodiment, the proxy server 311 can be considered to provide a “whitelisting” functionality (i.e., a service provider designates a list of approved URL's or MCC's) or a “blacklisting” functionality (i.e., a service provider designates a list of prohibited URL's or MCC's). In either case, operation S555 may be used to extract from the current payment transaction request a data element (e.g., MNC) that identifies the network service provider, and then perform a lookup (e.g., in database 313) to determine whether the corresponding service provider contains a “whitelist” or a “blacklist” of URL's or MCC's. According to S555, if the corresponding service provider contains a “whitelist” of URL's or MCC's, the proxy server 311 may only be allowed to forward a payment transaction request to the payment provider if the URL or MCC extracted from such request matches one of those in the designated list. On the other hand, if the service provider has designated a “blacklist” of URL's or MCC's, operation S555 would be used to block the payment transaction request from proceeding to the payment provider if the extracted URL or MCC is found on the designated list.

Referring again to FIG. 5, in accordance with the analysis conducted in S555, a decision is made in operation S560 as to whether the risk level associated with the current payment transaction request is acceptable. If the risk level is deemed acceptable, the payment transaction is allowed to proceed according to S565, e.g., by transmitting to the payment provider 330 the required information that was originally stripped from the payment processing request. The results of processing the payment transaction (including payment authorization and financial audit information) may then be redirected from the payment provider 330 to the web server 320A hosting the retailer website.

On the other hand, if operation S560 determines that the risk level is unacceptably high, the payment transaction is blocked according to S570. If the payment transaction is blocked in operation S570, the proxy server 311 could be configured to perform an additional operation (not shown) of redirecting the user of the browser 200 to an alternative transaction processing flow that is specified by the payment provider 330. Such alternative transaction processing flow could, e.g., ask the user to provide additional information that would help in completing the transaction.

Furthermore, although not shown in FIG. 5, it is contemplated that the proxy server 311 could perform other additional operations than those discussed above in connection with operations S555 through S570 when receiving a redirected payment transaction request.

For instance, the proxy server 311 could be programmed to evaluate whether the payment transaction request is missing any data necessary for processing the payment transaction. If there is any missing data, the proxy server 311 could respond in one of several ways. For instance, the proxy server 311 might be able to analyze the corresponding profile and extract the missing information from the profile (and possibly forward such information to the payment provider 330). As an alternative, or if the profile does not contain the information, the proxy server 31 could attempt to open a parallel channel of communication with the browser 200, and ask the browser 200 to issue a parallel HTTP request to be channeled through a different network or gateway that could supply the missing information. For example, if the browser 20 is presently communicating via a Wi-Fi network, the proxy server 311 could ask the browser 200 to send a parallel request through the mobile carrier's network, which would allow the mobile carrier to append the headers/information that is required by the payment provider 330 to complete the payment transaction.

Also, as another means of coping with the payment transaction request that is missing critical information), the proxy server 311 could be configured to redirect the browser 200 to an alternative transaction processing flow designated by the payment provider 330 which, e.g., asks the user directly to provide the missing information.

Another example of an additional operation that could be implemented by proxy server 311 is that of updating the corresponding profile in database 313 based on the results of the risk level assessment performed in operations S555 and S560.

Referring again to operation S520 of FIG. 5, if the received webpage request is determined not to be a redirected payment transaction request, but instead a request received directly from a client device 300 via the mobile network, then processing proceeds to operation S525. According to S525, a record of the webpage request is generated. In this record, the proxy server 311 (e.g., in the data extractor and logging module 402) may create a log file including the user-neutral identifier, the requested URL, and the other data element(s) extracted according to S515 as described above (e.g., unique device identifier, device type, device location, and/or network service provider).

After the record of the webpage request is generated, it is used to create or update the profile for the corresponding user-neutral identifier in the database 313 as shown in operation S530 of FIG. 5. This could be performed by the profile manager and analyzer module 403 of the proxy server 311. Although FIG. 5 illustrates an embodiment in which the corresponding profile is updated in S530 as soon as each record is generated, this need not be the case. For instance, an alternative would be to program the proxy server 311 to update multiple profiles in the database 313 (as necessary) based on the records of webpage requests received from respective client devices 300 periodically (e.g., at prescribed times). Another alternative might be to wait for the proxy server to generate a particular number of records before updating the profiles in the database 313. Another possibility would be to program the proxy server 311 to update an individual profile in the database 313 only after a threshold number of records containing the same user-neutral identifier are generated.

As noted above, a profile may simply comprise a collection of records that correspond to the same user-neutral identifier. As such, operation S530 may simply reformat the record(s) to be added as part of the profile. In an alternative embodiment, however, the updating could include additional processing of the information contained in the record(s) and the profile.

For instance, certain information from the extracted data element(s) may be categorized for purposes of updating the profile. E.g., if an extracted data element provides the specific geographical location of the device 300 in terms of longitude/latitude coordinates, it might be beneficial to categorize this information more generally according to city, state/province, or even more generally according to country. Of course, other types of data elements could also be categorized, e.g., if an extracted data element describes a device type in terms of make and model, it could possibly be generalized as “mobile” or “desktop” for purposes of updating the profile.

Furthermore, operation S530 may also perform some statistical processing of information in order to update the profile in view of the newly-generated record(s). Such processing might allow the profile to indicate “expected” values for data element(s) for webpage requests of a particular user-neutral identifier. For instance, if each webpage request included the device location as a data element, statistical processing may be performed as new records are generated to determine whether the corresponding user generally stays in one geographical area (e.g., city) or is likely to travel a lot. This could allow the profile to contain additional information regarding the expected range of device locations, which can be useful for assessing a risk level based on the location from which a payment transaction request is received.

Referring again to FIG. 5, according to operation S535 the webpage request is forwarded by the proxy server 311 to a web server 320, 320A or to a payment provider 330 as appropriate. As alluded to above, when the client device 300 is initially transmitting a payment transaction request to a payment provider 330 (as designated by the URL of the request), in S535 the proxy server 311 forwards the request to the appropriate payment provider 330, which in turn could redirect the request back to the proxy server 311. If, on the other hand, the request is a webpage request to a web server 320, 320A, then operation S535 causes the proxy server 311 to forward the webpage request to the appropriate web server 320, 320A, as designated in the requested URL, to retrieve the corresponding webpage for the client device 300.

In operation S540, if the request was for a webpage residing on a web server 320, 320A, the requested webpage may be received in S540. Such webpage may be received from the corresponding web server 320, 320A, or possibly from the proxy server's 311 own cache if the server 311 maintains cached versions of previously-retrieved webpages.

Upon receiving a webpage from a web server 320, 320A in S540, the proxy server 311 may optionally modify the webpage according to S545 to be more suitable for rendering on the client device 300. For instance, such modification may include transcoding the webpage (as described above in connection with the webpage transcoder 408 of FIG. 4). In performing such transcoding, the proxy server 311 may be able to ascertain the type of client device 300 from a data element within the webpage request.

In addition (or alternative) to such transcoding, operation S545 may also be used to modify the webpage in accordance with user-designated settings. For example, the proxy server 311 could query the database 313 based on the user-neutral identifier that is included in the webpage request, and analyze the corresponding profile to determine whether the user has set any preferences that can be used to modify the webpage. It is also possible that S545 could be used to modify the webpage in a similar manner as cookies are traditionally used. In fact, it would be possible for the proxy server 311 to analyze a cookie extracted from the webpage, and modify the webpage according to such analysis. Furthermore, in S545, the proxy server 311 could also modify the requested webpage in order to remove certain types of intrusive code intended to be stored to the client device 300, e.g., cookies. Other types of modifications are possible as well, e.g., operation S545 could even be used to enhance search results by highlighting words that match the user's search query. It should be noted, as indicated by the dotted lines for S545 in FIG. 5, it is optional for the proxy server 311 to modify the retrieved webpage before transmitting it to the browser 200 of the requesting client device 300 according to S550.

Referring again to FIG. 5, operation S550 may be used to transmit a requested webpage for rendering by the web browser 200 on the client device 300.

It should be noted that process 500 as illustrated in FIG. 5 may be altered, and that various ones of the illustrated operations may be omitted or re-ordered as desired.

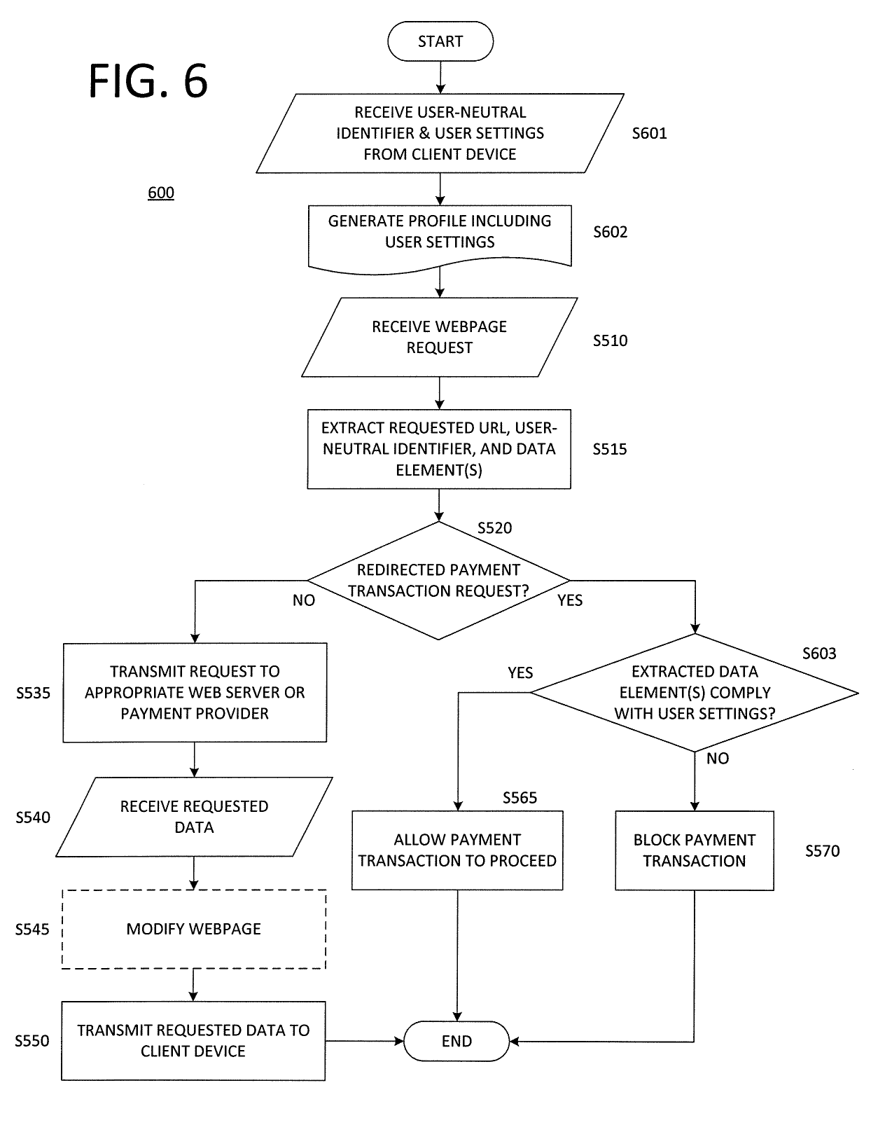

Now, reference will be made to FIG. 6 which illustrates an alternative exemplary embodiment in which the proxy server 311 is configured to carry out another process 600. It should be noted that the process 600 of FIG. 6 includes various operations, which are similar to ones illustrated in FIG. 5, and thus have similar reference numbers. Since these operations have already been described above in connection with FIG. 5, descriptions of these operations will not be repeated here.

The embodiment of FIG. 6 differs from the embodiment of FIG. 5 in that it is not necessary to analyze the data element(s) extracted from a current (redirected) payment transaction request in comparison with the data elements contained in previous requests. Instead, the proxy server 311 (e.g., in the profile manager and analyzer module 403) may simply analyze the extracted data element(s) of the redirected payment transaction request in view of rules or settings, which have been set by a user in the corresponding profile (as described earlier in connection with operation S555). As shown in FIG. 6, it is not necessary in process 600 to consider past history of extracted data elements when determining whether the payment transaction request should be allowed to pass on to the payment provider 300.

According to operations S601 and S602 of FIG. 6, for each user-neutral identifier, the proxy server 311 may allow the user to designate which particular values of data elements (such as unique identifier of device 300, device type, device location, and/or service provider) must be contained within a payment transaction request to allow the underlying transaction to be processed by the payment provider 330. Alternatively, the user can designate data element values that will cause the underlying payment transaction to be blocked. These user settings can be transmitted to the proxy server 311 via the browser 200, and upon receipt in S601 the proxy server 311 can modify the profile that corresponds to the browser's 200 user-neutral identifier accordingly. Since the past history of webpage requests is not used to analyze a risk level of the payment transaction, there is no need to generate records and modify the profile based on webpage requests, and thus such operations are not illustrated in FIG. 6.

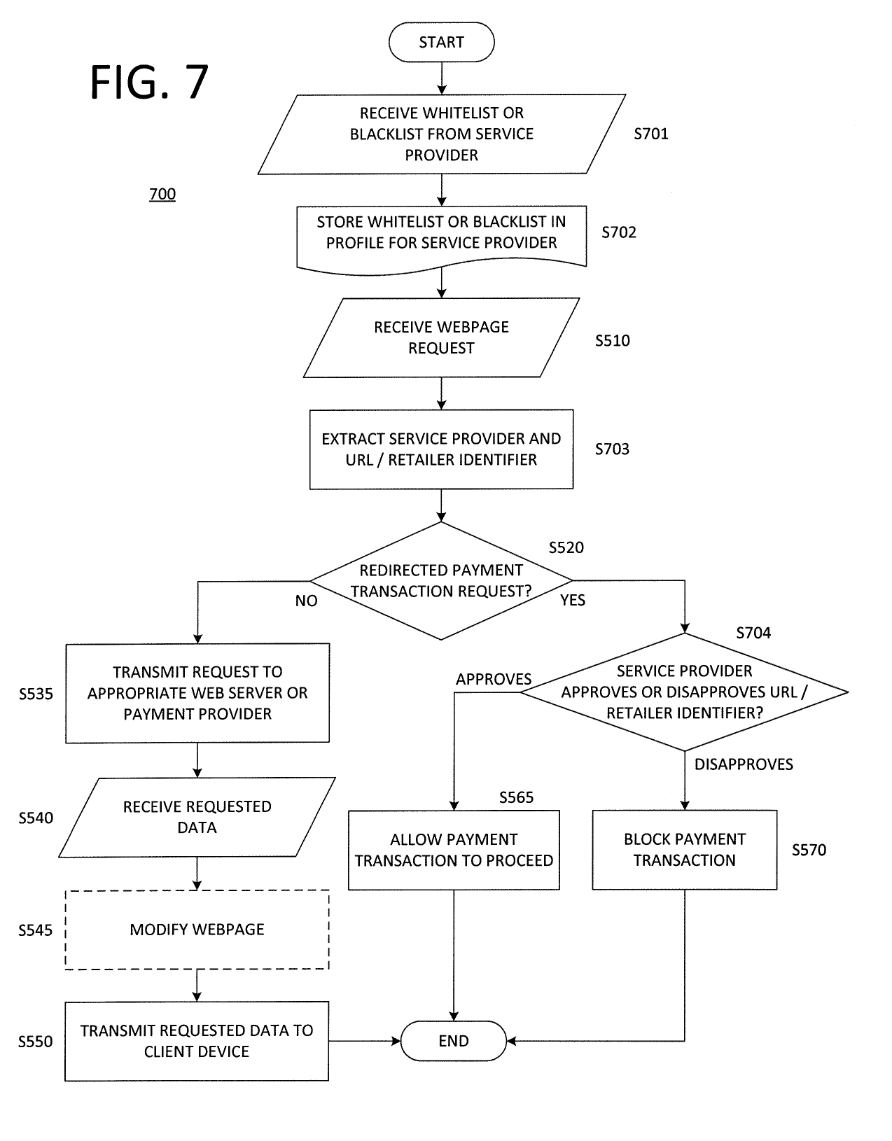

Now, reference will be made to FIG. 7 which illustrates another alternative embodiment in which the proxy server 311 is configured to carry out another process 700. In FIG. 7, process 700 includes various operations, which are similar to ones illustrated in FIG. 5 and thus have similar reference numbers. Since these operations have already been described above in connection with FIG. 5, such descriptions will not be repeated here.

The embodiment of FIG. 7 differs from FIG. 5 in that it is not necessary to analyze the data element(s) extracted from a current (redirected) payment transaction request in comparison with the data elements contained in previous requests. However, the embodiment of FIG. 7 distinguishes over the embodiment of FIG. 6 in that, instead of comparing the data element(s) of the redirected payment transaction request to user settings, the process 700 compares the extracted URL (or a retailer identifier, such as an MCC) to either a “whitelist” or “blacklist” of URL's or websites as defined by a network service provider.

According to operation S701 of FIG. 7, the proxy server 311 receives either a “whitelist” of websites (URL's) or retailers (e.g., MCC's) approved for payment transactions, or a “blacklist” of websites or retailers which are not trusted and thus disapproved for payment transactions. As shown in operation S702, the proxy server 311 may store the received list in a profile (e.g., in database 313) that has been set up for the service provider who sent the list. It is possible that the proxy server 311 may serve client devices 300 of multiple service providers, and maintain a different profile for each service provider.

Upon receiving a webpage request from a client device 300, in operation S703 the proxy server 311 (e.g., in data extractor and logging module 402) may extract therefrom the requested URL or retailer identifier (e.g., MCC) and information identifying the service provider (e.g., MNC). As such, if the request is determined to be a payment transaction request, according to operation S704 the proxy server 311 can determine whether the service provider would approve or disapprove going forward payment transaction by looking up the service provider's profile and comparing it with the extracted URL or retailer identifier. Particularly, if a “whitelist” has been set up in the service provider's profile, then S704 may require that the extracted URL or retailer identifier be included within the service provider's list, or otherwise correspond to a website or domain name that is included in the list, in order for the payment transaction request to be deemed approved and allowed to pass to the payment provider 330. Conversely, if a “blacklist” has been set up in the profile, then S704 deems the payment transaction request is disapproved (and thus blocked) only if the requested URL or retailer identifier is found in the service provider's list, or otherwise corresponds to a website or domain name within the list.

Similar to FIG. 5, the respective processes 600 and 700 of FIGS. 6 and 7 may be altered by omitting various operations or re-ordering them as desired. Further, it would be possible to implement any combination of embodiments illustrated in FIGS. 5, 6, and 7 as desired.

Next, reference will be made to FIG. 8. Particularly, FIG. 8 is a data flow diagram illustrating interactions between a client device 300, a proxy server 311, a web server hosting a retail site 320A, and a payment provider 330 according to an exemplary embodiment of the present invention. In the following description of FIG. 8, parenthetical references are used to link various data flows with corresponding operations illustrated in FIG. 5.

It should be noted that FIG. 8 is provided for purposes of example, and is not intended to be limiting on the invention. For instance, the sequence of data flows in this figure may be changed, and certain data flows may be omitted.

For purposes of FIG. 8, the user of the client device 300 is presumed to be viewing a website of an Internet retailer, hosted by the web server 320A, when she decides to click on an icon or link to a “Checkout” page. In response, the web browser 200 of the client device 300 transmits a webpage request, including at least the user-neutral identifier of that browser 200 and the requested URL, as illustrated by data flow 801. This webpage request is received by the proxy server 311 (S510). The proxy server 311 may generate a record of this request (S525) and process it in order to update the corresponding profile (S530). In order to retrieve the requested webpage for the client device 300, the proxy server 311 transmits the request to the web server 320A as shown in data flow 802 (S535). In response, the proxy server 311 receives the corresponding webpage (i.e., “Checkout” page) from the web server 320A according to data flow 703 (S540). It should be noted, however, that it is possible that data flows 802 and 803 could be omitted in case the proxy server 311 already has a cached copy of the “Checkout” webpage. The proxy server 311 may transmit the webpage to the client device 300 according to data flow 804 (S550), possibly after having modified or transcoded the webpage (not shown).

After the client device 300 receives the “Checkout” webpage, the web browser 200 is able to display or render it to the user. This webpage may display a confirmatory listing of items to be purchased, as well as means for the user to enter various payment transaction information to be processed by the payment provider 330 (e.g., credit card or bank account information, address, and/or whatever else is needed by the payment provider 330 to process payment). The “Checkout” page may also include a “Buy” button which is clicked by the user to complete the purchase, thus causing the browser 200 to transmit the payment transaction request according to data flow 805. When the proxy server 311 initially receives this request (S510), the proxy server 311 may use it to update the corresponding profile (S525 and S530), and then transmit the request to the payment provider according to data flow 806 (S550), as similarly done with other types of webpage requests. When the payment provider 330 receives this payment processing request, it may determine that necessary information has been removed from the HTTP header information, and thus redirect the payment processing request to the proxy server 311 according to data flow 807. Upon again receiving the request (S510), and determining that it is a redirected payment transaction request (S520), the proxy server 311 may analyze the request (S555) to assess the risk level associated with the underlying transaction. If the risk level is acceptably low (YES decision in S560), the proxy server 311 may allow the purchase transaction to be processed (S565) by forwarding the missing HTTP header information to the payment provider 330 according to data flow 808. Thereafter, the payment provider 330 can process the payment transaction information in the request.

As shown in FIG. 8, the results of processing by the payment provider 330 may be redirected to the web server 320A hosting the retailer website. Although not shown in FIG. 8, the retailer website may transmit to the client device 300 (e.g., via proxy server 311) a webpage confirming that the purchase has been made, and in the case that online content was being purchased, transmit such content to the client device 300.

While particular embodiments are described above for purposes of example, the present invention covers any and all obvious variations as would be readily contemplated by those skilled in the art.

1. A method comprising:
registering by a server, user-neutral identifiers for web browsers installed on respective electronic devices;
receiving at the server, webpage requests transmitted by the web browsers via a network, each of said webpage requests including a URL and a corresponding user-neutral identifier;
creating by said server, respective records of the webpage requests;
processing the records to update profiles that correspond to the same user-neutral identifiers, respectively;
receiving a webpage request redirected from a payment provider, which includes a particular user-neutral identifier and payment transaction information, after the profile corresponding to the particular user-neutral identifier has been created;
determining, based on the profile corresponding to the particular user-neutral identifier, whether payment should be processed according to the payment transaction information; and
upon determining that the payment should be processed, transmitting data to the payment provider prompting the payment provider to process payment according to the payment transaction information,
wherein each user-neutral identifier is registered without requiring the corresponding web browser to visit any webpage,
wherein the user-neutral identifiers are registered in such manner as to ensure that they uniquely identify the web browser issuing each of said webpage requests from others of said plurality of web browsers without providing user-specific information.

2. The method of claim 1, further comprising:
extracting, from each of the received webpage requests, one or more data elements for inclusion in the respective record,
wherein the one or more data elements include at least one of:
a specific identifier of the electronic device associated with the corresponding user-neutral identifier;
a type of the electronic device associated with the corresponding user-neutral identifier;
a location of the electronic device associated with the corresponding user-neutral identifier; and
a service provider servicing the electronic device associated with the corresponding user-neutral identifier.

3. The method of claim 2, wherein the profile corresponding to each user-neutral identifier is updated based on the one or more data elements included in records corresponding to the same user-neutral identifier.

4. The method of claim 3, further comprising:
analyzing the profile of the particular user-neutral identifier to determine expected values of the one or more data elements based on a historical values of the one or more data elements included in records corresponding to the particular user-neutral identifier,
wherein the determination of whether the payment should be processed includes:
obtaining the one or more data elements from the webpage request including the payment transaction information; and
determining whether the obtained one or more data elements are consistent with the expected values.

5. The method of claim 2, wherein the determination of whether the payment should be processed includes:
obtaining the one or more data elements from the webpage request including the payment transaction information;
comparing the obtained one or more data elements to the profile corresponding to the particular user-neutral identifier; and
judging whether or not the payment should be processed on the basis of the comparison.

6. The method of claim 5, wherein the at least one of the obtained one or more data elements is compared to a set value in the profile corresponding to the particular user-neutral identifier, the set value being designated a user of the corresponding web browser.

7. The method of claim 5,
wherein the at least one of the obtained one or more data elements identifies a website or retailer to which payment is to be made according to the payment transaction information, and
wherein the identified website is compared to a set list of websites or retailers in the profile corresponding to the particular user-neutral identifier, the set list being designated by a service provider.

8. The method of claim 1, further comprising:
determining whether the payment transaction information in the redirected webpage is complete, and
if the payment transaction information is missing information necessary to process payment, extracting the missing information from the profile corresponding to the particular user-neutral identifier and forwarding the extracted information to the payment provider.

9. The method of claim 1, further comprising:
determining whether the payment transaction information in the redirected webpage is complete, and
if the payment transaction information is missing information necessary to process payment, using a parallel communication channel between components of the system to parallel process the transaction via an alternative gateway to obtain the missing information and forwarding the retrieved information to the payment provider.

10. A system comprising:
a server including at least one processing device programmed to:
register user-neutral identifiers for web browsers installed on respective electronic devices,
receive webpage requests transmitted by the web browsers via a network, each of said webpage requests including a URL and a corresponding user-neutral identifier,
create respective records of the webpage requests,
process the records to update profiles that correspond to the same user-neutral identifiers, respectively,
receive a webpage request redirected from a payment provider, which includes a particular user-neutral identifier and payment transaction information, after the profile corresponding to the particular user-neutral identifier has been created,
determine, based on the profile corresponding to the particular user-neutral identifier, whether payment should be processed according to the payment transaction information; and
upon determining that the payment should be processed, transmit data to the payment provider prompting the payment provider to process payment according to the payment transaction information; and
a database storing the profiles,
wherein each user-neutral identifier is registered with requiring the corresponding web browser to visit any webpage, and
wherein said user-neutral identifiers are registered in such manner as to ensure that they uniquely identify the web browser issuing each of said webpage requests from others of said plurality of web browsers without providing user-specific information.

11. The system of claim 10,
wherein the at least one processing device is further programmed to extract, from each of the received webpage requests, one or more data elements for inclusion in the respective record, and
wherein the one or more data elements include at least one of:
a specific identifier of the electronic device associated with the corresponding user-neutral identifier;
a type of the electronic device associated with the corresponding user-neutral identifier;
a location of the electronic device associated with the corresponding user-neutral identifier; and
a service provider servicing the electronic device associated with the corresponding user-neutral identifier.

12. The system of claim 11, wherein the profile corresponding to each user-neutral identifier is updated based on the one or more data elements included in records corresponding to the same user-neutral identifier.

13. The system of claim 12,
wherein the at least one processing device is further programmed to analyze the profile of the particular user-neutral identifier to determine expected values of the one or more data elements based on a historical values of the one or more data elements included in records corresponding to the particular user-neutral identifier, and
wherein the determination of whether the payment should be processed includes:
obtaining the one or more data elements from the webpage request including the payment transaction information; and
determining whether the obtained one or more data elements are consistent with the expected values.

14. The system of claim 11, wherein the determination of whether the payment should be processed includes:
obtaining the one or more data elements from the webpage request including the payment transaction information;
comparing the obtained one or more data elements to the profile corresponding to the particular user-neutral identifier; and
judging whether or not the payment should be processed on the basis of the comparison.

15. The system of claim 14, wherein the at least one of the obtained one or more data elements is compared to a set value in the profile corresponding to the particular user-neutral identifier, the set value being designated a user of the corresponding web browser.

16. The system of claim 14,
wherein the at least one of the obtained one or more data elements identifies a website or retailer to which payment is to be made according to the payment transaction information, and
wherein the identified website is compared to a set list of websites or retailers in the profile corresponding to the particular user-neutral identifier, the set list being designated by a service provider.

17. The system of claim 10, wherein the at least one processing device is further programmed to:
determine whether the payment transaction information in the redirected webpage is complete, and
if the payment transaction information is missing information necessary to process payment, extract the missing information from the profile corresponding to the particular user-neutral identifier and forward the extracted information to the payment provider.

18. The system of claim 10, wherein the at least one processing device is further programmed to:
determine whether the payment transaction information in the redirected webpage is complete, and
if the payment transaction information is missing information necessary to process payment, use a parallel communication channel between components of the system to parallel process the transaction via an alternative gateway to obtain the missing information and forward the retrieved information to the payment provider.

19. A non-transitory computer-readable medium on which are stored instructions executable by a processor to perform a process comprising:
registering user-neutral identifiers for web browsers installed on respective electronic devices;
receiving webpage requests transmitted by the web browsers via a network, each of said webpage requests including a URL and a corresponding user-neutral identifier;
creating respective records of the webpage requests;
processing the records to update profiles that correspond to the same user-neutral identifiers, respectively;
receiving a webpage request redirected from a payment provider, which includes a particular user-neutral identifier and payment transaction information, after the profile corresponding to the particular user-neutral identifier has been created;
determining, based on the profile corresponding to the particular user-neutral identifier, whether payment should be processed according to the payment transaction information; and
upon determining that the payment should be processed, transmitting data to the payment provider prompting the payment provider to process payment according to the payment transaction information,
wherein each user-neutral identifier is registered without requiring the corresponding web browser to visit any webpage,
wherein the user-neutral identifiers are registered in such manner as to ensure that they uniquely identify the web browser issuing each of said webpage requests from others of said plurality of web browsers without providing user-specific information.

20. The computer-readable medium of claim 19,
wherein the process further comprises extracting, from each of the received webpage requests, one or more data elements for inclusion in the respective record, and
wherein the one or more data elements include at least one of:
a specific identifier of the electronic device associated with the corresponding user-neutral identifier;
a type of the electronic device associated with the corresponding user-neutral identifier;
a location of the electronic device associated with the corresponding user-neutral identifier; and
a service provider servicing the electronic device associated with the corresponding user-neutral identifier.

21. The computer-readable medium of claim 20, wherein the profile corresponding to each user-neutral identifier is updated based on the one or more data elements included in records corresponding to the same user-neutral identifier.

22. The computer-readable medium of claim 21,
wherein the process further comprises analyzing the profile of the particular user-neutral identifier to determine expected values of the one or more data elements based on a historical values of the one or more data elements included in records corresponding to the particular user-neutral identifier, and
wherein the determination of whether the payment should be processed includes:
obtaining the one or more data elements from the webpage request including the payment transaction information; and
determining whether the obtained one or more data elements are consistent with the expected values.

23. The computer-readable medium of claim 20, wherein the determination of whether the payment should be processed includes:
obtaining the one or more data elements from the webpage request including the payment transaction information;
comparing the obtained one or more data elements to the profile corresponding to the particular user-neutral identifier; and
judging whether or not the payment should be processed on the basis of the comparison.

24. The computer-readable medium of claim 23, wherein the at least one of the obtained one or more data elements is compared to a set value in the profile corresponding to the particular user-neutral identifier, the set value being designated a user of the corresponding web browser.

25. The computer-readable medium of claim 23,
wherein the at least one of the obtained one or more data elements identifies a website or retailer to which payment is to be made according to the payment transaction information, and
wherein the identified website is compared to a set list of websites or retailers in the profile corresponding to the particular user-neutral identifier, the set list being designated by a service provider.

26. The computer-readable medium of claim 19, wherein the process further comprises:
determining whether the payment transaction information in the redirected webpage is complete, and
if the payment transaction information is missing information necessary to process payment, extracting the missing information from the profile corresponding to the particular user-neutral identifier and forwarding the extracted information to the payment provider.

27. The computer-readable medium of claim 19, wherein the process further comprises:
determining whether the payment transaction information in the redirected webpage is complete, and
if the payment transaction information is missing information necessary to process payment, using a parallel communication channel between components of the system to parallel process the transaction via an alternative gateway to obtain the missing information and forwarding the retrieved information to the payment provider.
